(19) United States
(12) Patent Application Publication
(10) Pub. No.: US 2016/0136466 A1
(43) Pub. Date: May 19, 2016

(54) DETONATION ARRESTOR FOR CAVERN STORAGE

(71) Applicant: Air Liquide Large Industries U.S. LP, Houston, TX (US)

(72) Inventor: Ronald STRYBOS, Kountze, TX (US)

(21) Appl. No.: 14/711,036

(22) Filed: May 13, 2015

Related U.S. Application Data
(60) Provisional application No. 62/081,284, filed on Nov. 18, 2014.

(51) Int. Cl. A62C 4/02; B65G 5/00; A62C 3/06

(52) U.S. Cl. CPC A62C 4/02; A62C 3/06; B65G 5/00

(57) ABSTRACT

A hydrogen pipeline detonation arrestor is provided. The detonation arrestor includes a pipeline spool, having a segment length, an inner volume, an outer surface. The detonation arrester also includes a detonation barrier having a plurality of axially aligned quench pipes located within the inner volume. The detonation arrester is located within a hydrogen pipeline upstream or downstream of a hydrogen salt cavern storage facility.

### CROSS REFERENCE TO RELATED APPLICATIONS

This application claims the benefit of priority under 35 U.S.C. §119 (a) and (b) to US Provisional Patent Application No. 62/081,284 filed Nov. 18, 2014, the entire contents of which are incorporated herein by reference.

### BACKGROUND

Leached caverns in salt formations are used to store large volumes flammable liquids and gases. It is found that a fire or deflagration in a product pipeline of a highly flammable gas or reactive product could enter a storage cavern. By introduction of a detonation arrestor in the product line at the wellhead, the flame front or deflagration will be broken up so that the flame, deflagration or explosion does not enter the cavern.

### SUMMARY

A hydrogen pipeline detonation arrestor is provided. The detonation arrestor includes a pipeline spool, having a segment length, an inner volume, an outer surface. The detonation arrester also includes a detonation barrier having a plurality of axially aligned quench pipes located within the inner volume. The detonation arrester is located within a hydrogen pipeline upstream or downstream of a hydrogen salt cavern storage facility.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates an embodiment of the invention;

FIG. 2 illustrates an embodiment of the invention;

FIG. 3 illustrates an embodiment of the invention;

FIG. 4 illustrates an embodiment of the invention;

FIG. 5 illustrates an embodiment of the invention; and

FIG. 6 illustrates an embodiment of the invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

Under certain conditions a fire, deflagration, or explosion can exist in a pipeline carrying highly flammable or reactive products. The velocity of the fire or deflagration, which approaches the speed of sound, carries the fire forward through the open cross section of the pipeline and can carry this fire into the cavern. The introduction of a pipe spool containing numerous tubes breaks up the flame front and reduces the flame velocity such that the flame is extinguished in situ.

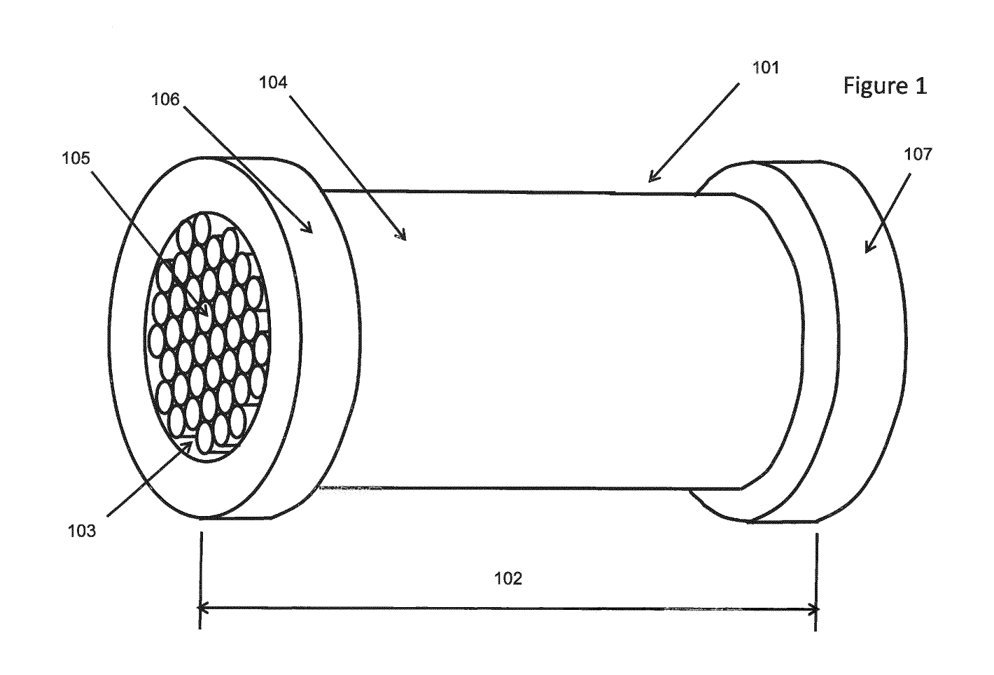

Turning to FIG. 1, in a first embodiment, a hydrogen pipeline detonation arrestor includes a pipeline spool 101, a segment length 102, an inner volume 103, and an outer surface 104. The segment length 102 may be from 8 feet to 12 feet. The pipeline spool 101 has a first flange 106 and a second flange 107, sized to mate with a product pipeline diameter. The detonation barrier also includes a plurality of axially aligned quench pipes 105 located within the inner volume 103. The quench pipes 105 may be constructed of steel tubes, and may have nominal sizes of ½ inch, ⅝ inch, ¾ inch or 1 inch in diameter.

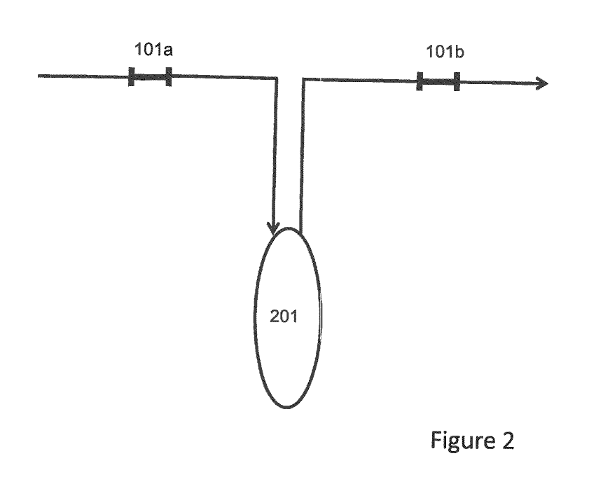

As indicated in FIG. 2, the detonation arrester may be located within a hydrogen pipeline upstream 101a or downstream 101b of a salt cavern storage facility 201. The pipeline spool 101 is of the product pipeline diameter and designed to contain the operating pressure of the pipeline.

The pipeline spool 101 is designed to contain the operating pressure of the pipeline. The quench pipes 105 may be constructed of steel tubes, and may have nominal sizes of ½ inch, ⅝ inch, ¾ inch or 1 inch in diameter.

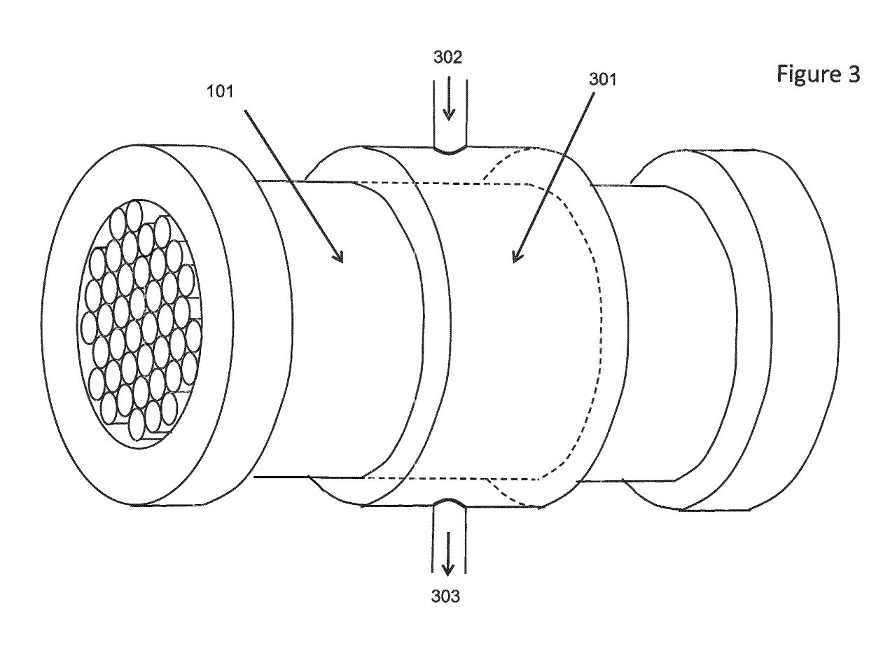

As indicated in FIG. 3, the hydrogen pipeline detonation arrestor may have a fluid cooling jacket 301. A supply of cooling fluid is introduced into the fluid cooling jacket 301 by an inlet port 302, and the cooling fluid exits by an outlet port 303. The cooling fluid may be water. In the interest of clarity, the fluid cooling jacket 301 is shown as only covering a central portion of pipeline spool 101; however, the fluid cooling jacket 301 may cover 50%, 75%, 100% of the pipeline spool 101.

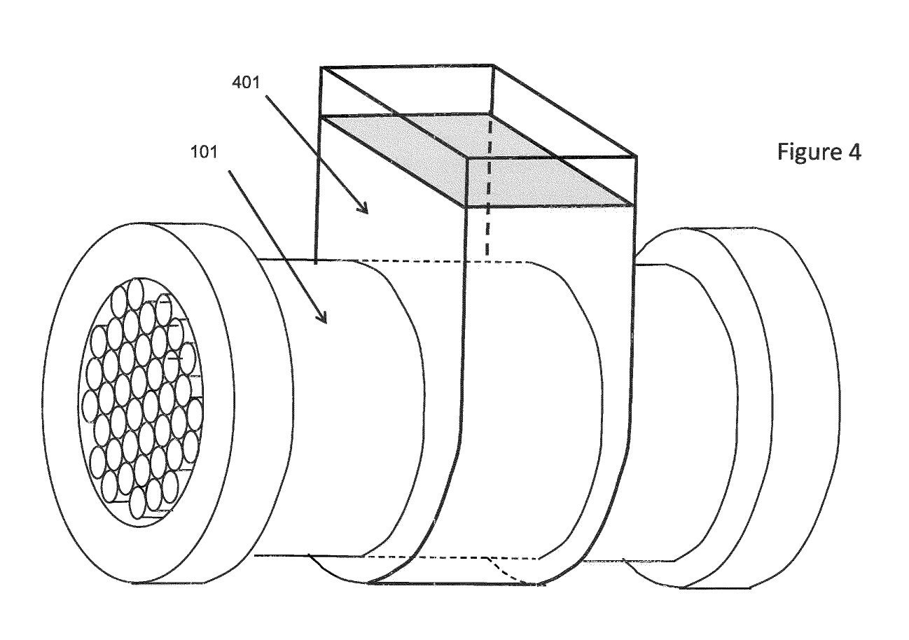

As indicated in FIG. 4, the hydrogen pipeline detonation arrestor may be submerged in a cooling fluid bath 401. A supply of cooling fluid is maintained into the cooling fluid bath 401. The cooling fluid may be water. In the interest of clarity, the cooling fluid bath 401 is shown as only covering a central portion of pipeline spool 101; however, the cooling fluid bath 401 may cover 50%, 75%, 100% of the pipeline spool 101.

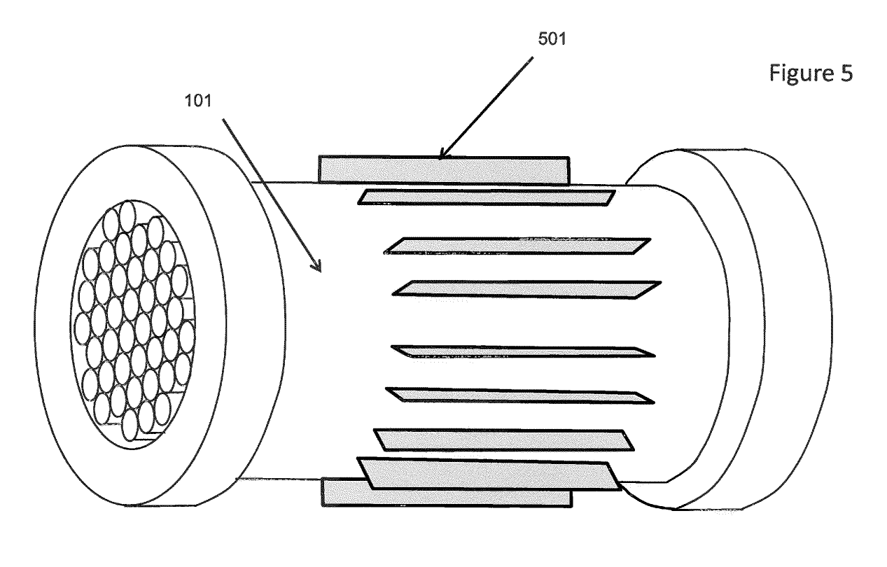

As indicated in FIG. 5, the hydrogen pipeline detonation arrestor may have enhanced heat transfer surface area (fins) 501 attached to the outer surface 104 of the pipeline spool. In the interest of clarity, the enhanced heat transfer surface area 501 is shown as only covering a central portion of pipeline spool 101; however, the enhanced heat transfer surface area 501 may cover 50%, 75%, 100% of the pipeline spool 101.

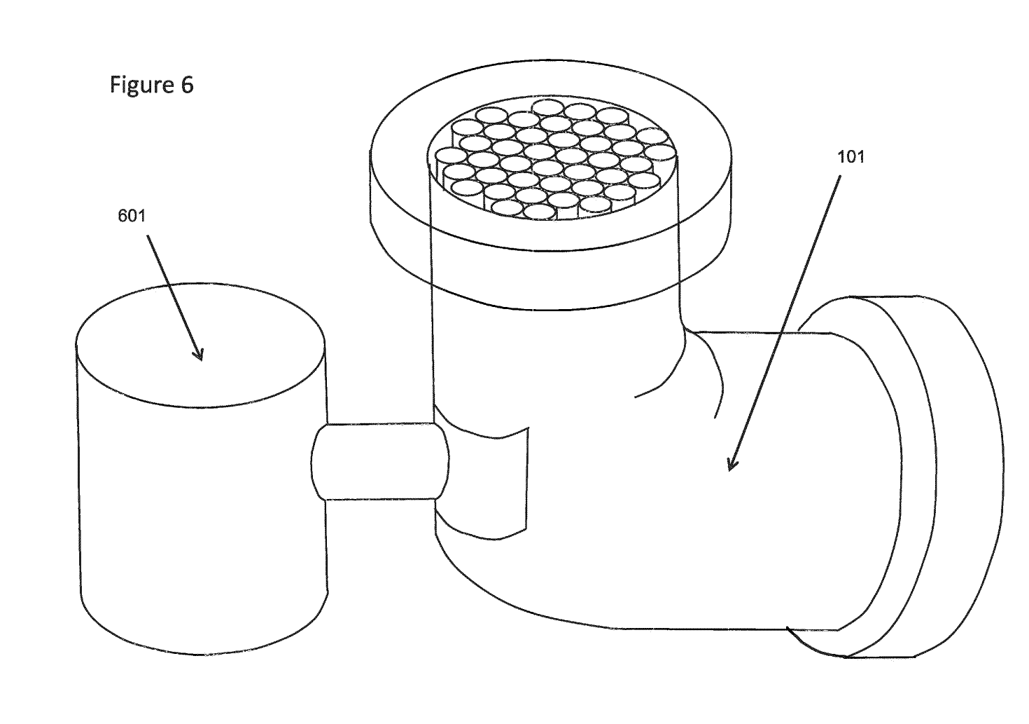

As indicated in FIG. 6, the hydrogen pipeline detonation arrestor may have a mechanical shock arrester 601 attached to the pipeline spool 101.

The detonation arrester 101 may be used for storing hydrogen, methane, ethane, ethylene, or propylene.

1. A hydrogen pipeline detonation arrestor comprising;
a pipeline spool, comprising a segment length, an inner volume, an outer surface,
a detonation barrier comprising plurality of axially aligned quench pipes located within the inner volume,
wherein the detonation arrester is located within a hydrogen pipeline upstream or downstream of a salt cavern storage facility.

2. The hydrogen pipeline detonation arrestor of claim 1, wherein the pipeline spool further comprises a fluid cooling jacket.

3. The hydrogen pipeline detonation arrestor of claim 1, wherein the pipeline spool is submerged in a cooling fluid bath.

4. The hydrogen pipeline detonation arrestor of claim 1, wherein the pipeline spool further comprises enhanced heat transfer surface area on the outer surface.

5. The hydrogen pipeline detonation arrester of claim 1, wherein the pipeline spool is fixedly attached to a mechanical shock arrester.

6. The hydrogen pipeline detonation arrester of claim 1, wherein the salt cavern storage facility is used for storing hydrogen, methane, ethane, ethylene, or propylene.

7. The hydrogen pipeline detonation arrester of claim 1, wherein the salt cavern storage facility is used for storing hydrogen.
